(19) United States
(12) Patent Application Publication
(10) Pub. No.: US 2024/0305495 A1
(43) Pub. Date: Sep. 12, 2024

(54) METHOD AND APPARATUS FOR INTEGRATED MANAGEMENT OF ENERGY BLOCKCHAIN TRANSACTIONS OF PLUS ENERGY

(71) Applicant: ELECTRONICS AND TELECOMMUNICATIONS RESEARCH INSTITUTE, Daejeon (KR)

(72) Inventors: Chang-Sic CHOI, Daejeon (KR); Tai-yeon KU, Daejeon (KR); Wan Ki PARK, Daejeon (KR)

(21) Appl. No.: 18/397,160

(22) Filed: Dec. 27, 2023

(30) Foreign Application Priority Data
Mar. 6, 2023 (KR) 10-2023-0028854

(51) Int. Cl. H04L 12/28; G06Q 50/06

(52) U.S. Cl. CPC H04L 12/2803; G06Q 50/06; G06Q 2220/00

(57) ABSTRACT

A method and system for managing energy blockchain transactions in plus energy are disclosed. The energy blockchain transaction management method includes obtaining message data generated by collecting messages including energy-related data of respective households from collectors installed respectively in the households; analyzing the message data and correcting the message data based on an analysis result obtained by the analyzing; and generating an energy blockchain transaction based on the corrected message data and transmitting the generated energy blockchain transaction to a blockchain system.

### CROSS-REFERENCE TO RELATED APPLICATIONS

This application claims the benefit of Korean Patent Application No. 10-2023-0028854 filed on Mar. 6, 2023, in the Korean Intellectual Property Office, the entire disclosure of which is incorporated herein by reference for all purposes.

### BACKGROUND

### 1. Field of Invention

One or more example embodiments relate to a method of managing energy data generated from plus energy and, more particularly, to a method and system for managing energy data using a blockchain system.

### 2. Description of Related Art

To respond to the global energy crisis for climate agreements and low-carbon growth, efforts for energy neutrality at the consumer level are necessary, and various energy conservation technologies, new and renewable energy, and energy storage devices are in continuous development. Research and development on various technologies has recently been ongoing to achieve energy neutrality where energy consumption and production are equal.

Plus energy, a technology provided for energy independence that is difficult to achieve by a single household, may group multiple households and connect households having a surplus of energy and households having a shortage of energy, and employ a joint renewable energy device and energy storage device, thereby enabling community-level energy independence.

Such community-level energy sharing may require storing and sharing, in a reliable way, information about energy production, consumption, and storage for both individual consumers and the public, and there is thus a need for the introduction of a technology for managing related energy data using a blockchain system.

Therefore, there is a desire for a method of generating a blockchain transaction that supports data reliability and accuracy to apply the characteristics of energy data to a blockchain system.

### SUMMARY

Example embodiments provide a method and device for collecting, in an integrated way, community-unit energy data including energy production, consumption, storage data, and the like, classifying the energy data by individual households, and processing the energy data in a form optimized for blockchain registration.

Example embodiments also provide a method and system for efficiently managing energy data generated in various environments, generating a blockchain transaction that supports data reliability and accuracy, and preventing an error that may occur due to duplicate transactions in the same block by applying a block generation period.

According to an example embodiment of the present disclosure, there is provided an energy blockchain transaction management method including: obtaining message data generated by collecting messages including energy-related data of respective households from collectors installed respectively in the households; analyzing the message data and correcting the message data based on an analysis result obtained by the analyzing; and generating an energy blockchain transaction based on the corrected message data and transmitting the generated energy blockchain transaction to a blockchain system.

The message data may include messages received from the collectors during a block generation period and may be stored in a unit of the block generation period.

The correcting may include identifying, from the message data, a household that has not transmitted a message during the block generation period; extracting a message corresponding to the identified household from message data of a previous block generation period; and setting the extracted message as a message received from the identified household during the block generation period and adding the set message to the message data.

The correcting may include identifying, from the message data, a household from which duplicate messages have been received; identifying a first received message among the messages corresponding to the identified household; and moving at least one remaining message, excluding the identified message, among the messages corresponding to the identified household, to message data of a subsequent block generation period.

The correcting may include identifying whether each of the messages included in the message data includes error data; and when a message including the error data is identified, correcting the identified message.

Each of the messages may include at least one of: an energy consumption data storing application programming interface (API) that is generated by collecting energy consumption data from each of the households by an energy consumption data collector in each of the collectors; an energy production data storing API that is generated by collecting operational status data of solar power or fuel cell power generation equipment installed in each of the households by a power generation and status data collector in each of the collectors; or an energy storage data storing API that is generated by collecting charging and discharging status data of an energy storage device installed in each of the households by a charging and discharging status data collector in each of the collectors.

The energy blockchain transaction management method may further include classifying the messages by household based on household identification data, and the transmitting to the blockchain system may include setting the household identification data as a key value and setting each of the messages as a data value, and generating an energy blockchain transaction corresponding to a household.

According to an example embodiment of the present disclosure, there is provided an energy blockchain transaction management system including: collectors installed in respective households and configured to collect energy-related data of the respective households and transmit messages including the collected data; and an integrated blockchain transaction management device configured to analyze message data, correct the message data based on an analysis result obtained by the analyzing, generate an energy blockchain transaction based on the corrected message data, and transmit the generated energy blockchain transaction to a blockchain system.

The message data may include messages received during a block generation period from the collectors and may be stored in a unit of the block generation period.

Each of the collectors may include at least one of: an energy consumption data collector configured to collect energy consumption data about energy consumed by each of the households; a power generation and status data collector configured to collect operational status data of solar power or fuel cell power generation equipment installed in each of the households; or a charging and discharging status data collector configured to collect charging and discharging status data of an energy storage device installed in each of the households.

According to an example embodiment of the present disclosure, there is provided an integrated blockchain transaction management device including: a household-specific message classifier configured to obtain message data generated by collecting messages including energy-related data of respective households from collectors installed respectively in the households; a message corrector configured to analyze the message data and correct the message data based on an analysis result obtained by the analyzing; and a transaction generator configured to generate an energy blockchain transaction based on the corrected message data and transmit the generated energy blockchain transaction to a blockchain system.

The message corrector may be configured to: identify, from the message data, a household that has not transmitted a message during a block generation period, extract a message corresponding to the identified household from message data of a previous block generation period, and set the extracted message as a message received from the identified household during the block generation period and add the set message to the message data.

The message corrector may be configured to: identify, from the message data, a household from which duplicate messages have been received, identify a first received message among the messages corresponding to the identified household, and move at least one message, excluding the identified message, among the messages corresponding to the identified household to message data of a subsequent block generation period.

The message corrector may be configured to: identify whether each of the messages included in the message data includes error data and, when a message including the error data is identified, correct the identified message.

Each of the messages may include at least one of: an energy consumption data storing API that is generated by collecting energy consumption data from each of the households by an energy consumption data collector in each of the collectors; an energy production data storing API that is generated by collecting operational status data of solar power or fuel cell power generation equipment installed in each of the households by a power generation and status data collector in each of the collectors; or an energy storage data storing API that is generated by collecting charging and discharging status data of an energy storage device installed in each of the households by a charging and discharging status data collector in each of the collectors.

The household-specific message classifier may be configured to: classify the messages by household based on household identification data, and the transaction generator may be configured to: set the household identification data as a key value and set each of the messages as a data value, and generate an energy blockchain transaction corresponding to a household.

According to example embodiments described herein, community-unit energy data such as energy production, consumption, and storage data may be collected in an integrated manner and classified by individual households, and then be processed in a form optimized for blockchain registration.

According to example embodiments described herein, a technology for correcting errors and omissions in energy data may be applied.

According to example embodiments described herein, transactions may be rearranged based on a blockchain generation period to prevent a blockchain error that may occur when duplicate transactions are added to the same block, and a stable operation of a blockchain system may thus be enabled.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an energy blockchain transaction management system according to an example embodiment;

FIG. 2 is a diagram illustrating an integrated blockchain transaction management device according to an example embodiment;

FIG. 3 is a diagram illustrating example problems that may occur in energy blockchain transactions according to an example embodiment;

FIG. 4 is a diagram illustrating an example process of energy blockchain transaction management according to an example embodiment;

FIG. 5 is a flowchart illustrating an energy blockchain transaction management method according to an example embodiment; and

FIG. 6 is a flowchart illustrating a transaction processing process of an energy blockchain transaction management method according to an example embodiment.

### DETAILED DESCRIPTION

Hereinafter, example embodiments of the present disclosure will be described in detail with reference to the accompanying drawings. An energy blockchain transaction management method according to an example embodiment of the present disclosure may be performed by an energy blockchain transaction management system.

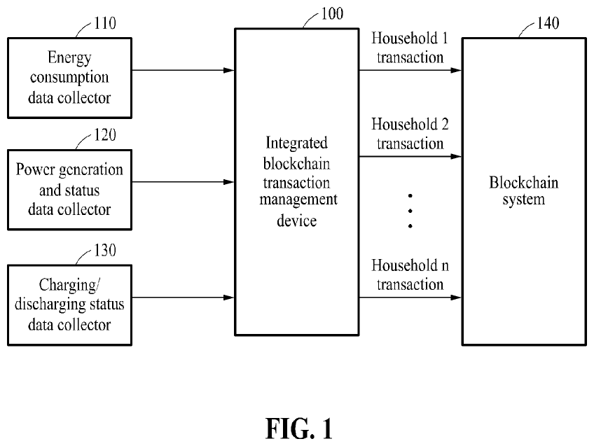

FIG. 1 is a diagram illustrating an energy blockchain transaction management system according to an example embodiment.

The energy blockchain transaction management system according to an example embodiment of the present disclosure may include collectors installed respectively in households, an integrated blockchain transaction management device 100, and a blockchain system 140. In this case, the collectors may be installed respectively in households that have subscribed to an energy blockchain transaction management service.

The collectors may collect energy-related data from the households and transmit messages including the collected data to the integrated blockchain transaction management device 100. For example, the collectors may each include at least one of an energy consumption data collector 110, a power generation and status data collector 120, and a charging/discharging status data collector 130. The messages may each be an application programming interface (API).

The energy consumption data collector 110 may collect energy consumption data about the energy consumed by each of the households. The energy consumption data collector 110 may generate an energy consumption data storing API based on the collected energy consumption data and transmit it to the integrated blockchain transaction management device 100.

The power generation and status data collector 120 may collect operational status data of solar power or fuel power generation equipment installed in each of the households. The power generation and status data collector 120 may generate an energy production data storing API based on the collected operational status data and transmit it to the integrated blockchain transaction management device 100.

The charging/discharging status data collector 130 may collect charging and discharging status data of an energy storage device installed in each of the households. The charging/discharging status data collector 130 may generate an energy storage data storing API based on the collected status data and transmit it to the integrated blockchain transaction management device 100.

The integrated blockchain transaction management device 100, which is based on plus energy, may classify and analyze the messages received from the collectors. The plus energy-based integrated blockchain transaction management device 100 may correct error data or omitted data in the messages. In addition, the plus energy-based integrated blockchain transaction management device 120 may transform the messages into a form of a blockchain transaction by performing an optimal arrangement operation according to a block generation period. For example, a blockchain transaction may be generated for each household, such as, for example, a transaction of household 1, a transaction of household 2, and a transaction of household n.

The blockchain system 140 may manage data about energy production, consumption, and storage by storing and managing blockchain transactions.

The energy blockchain transaction management system may collect, in an integrated manner, energy data such as data about energy production, consumption, storage, and the like at the community level, classify it by individual households, and process it in a form optimized for blockchain registration. The energy blockchain transaction management system may also apply a technology for correcting errors and omissions in the energy data.

In addition, the energy blockchain transaction management system may rearrange the transactions based on a block generation period to prevent a blockchain error that may occur when duplicate transactions are added to the same block, thereby stably operating the blockchain system 140.

The energy blockchain transaction management system may efficiently manage energy data generated in various environments and generate blockchain transactions that support data reliability and accuracy, and prevent an error that may occur by duplicate transactions in the same block by applying a block generation period, thereby stably operating the blockchain system 140.

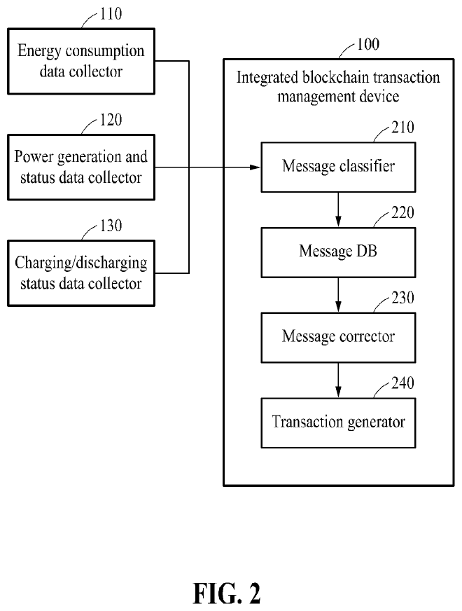

FIG. 2 is a diagram illustrating an integrated blockchain transaction management device according to an example embodiment.

As shown in FIG. 2, the energy blockchain transaction management device 100 may include a household-specific message classifier 210, a household-specific message database (DB) 220, a message corrector 230, and a transaction generator 240. In this case, the message classifier 210, the message DB 220, the message corrector 230, and the transaction generator 240 may be different processors as shown in FIG. 2 or may be modules included in a program executed by a processor.

The household-specific message classifier 210 may receive messages including energy-related data of respective households from collectors installed respectively in the households. For example, the message classifier 210 may receive an energy consumption data storing API, an energy production data storing API, and an energy storage data storing API from the energy consumption data collector 110, the power generation and status data collector 120, and the charging/discharging status data collector 130, respectively.

The message classifier 210 may also classify the received messages by household based on household identification data. In this case, the message classifier 210 may generate message data by setting the household identification data as a key value of blockchain data and processing, as a data value, a message received from a collector installed in a corresponding household. In this case, the message data may include messages received from the collectors during a block generation period and may be stored in a unit of the block generation period in the message DB.

For example, when the message classifier 210 receives the energy consumption data storing API, the production data storing API, and the storage data storing API respectively from the energy consumption data collector 110, the power generation and status data collector 120, and the charging/discharging status data collector 130 installed in household 1, the message classifier 210 may generate an energy API for household #1, which is message data including the energy consumption data storing API, the production data storing API, and the storage data storing API of the household 1. In addition, the message classifier 210 may repeat the foregoing process for households that subscribe to an energy blockchain transaction management service or households 1 through n that are grouped in a preset community unit among the households that subscribe to the energy blockchain transaction management service, and may generate respective energy APIs for household #1 through household # n.

The household-specific message DB 220 may store the message data generated by the message classifier 210 in the form of a DB.

The message corrector 230 may obtain the message data by loading it from the message DB 220. The message corrector 230 may also analyze the message data and correct the message data based on an analysis result obtained by the analyzing. For example, the message corrector 230 may analyze the message data to identify message data having an error in energy data and message data including a message that is not transferred periodically, and may then correct the identified message data.

For example, the message corrector 230 may identify, from the message data, a household that has not transmitted a message during the block generation period. The message corrector 230 may then extract a message corresponding to the identified household from message data of a previous block generation period. The message corrector 230 may then set the extracted message as a message received from the identified household during the block generation period and add the set message to the message data.

In addition, the message corrector 230 may identify, from the message data, a household from which duplicate messages are received. In this case, the message corrector 230 may identify a first received message among the messages corresponding to the identified household. The message corrector 230 may then move at least one remaining message, excluding the identified message, among the messages corresponding to the identified household, to message data of a subsequent block generation period.

In addition, the message corrector 230 may identify whether error data is included in each of the messages included in the message data. When a message including the error data is identified, the message corrector 230 may correct the identified message.

For example, the message corrector 230 may include an energy data profile including at least one of a range of data that may be normally collectable from each of the collectors or a normal range of energy-related data included in each of the messages. The message corrector 230 may also load the energy data profile stored in a separate storage medium or receive the energy data profile through an external connecting port.

In addition, the message corrector 230 may compare the energy-related data included in each of the messages received from the collectors to the energy data profile. In this case, the message corrector 230 may identify a message including energy-related data having a value that is out of the range included in the energy data profile as a message including the error data.

The message corrector 230 may then correct the energy-related data in the message that has the value out of the range included in the energy data profile to have a maximum or minimum value of the range included in the energy data profile. For example, when a message includes energy-related data having a value exceeding the range included in the energy data profile, the message corrector 230 may correct the energy-related data in the message to have a maximum value of the range included in the energy data profile. In addition, when a message includes energy-related data having a value less than the range included in the energy data profile, the message corrector 230 may correct the energy-related data in the message to have a minimum value of the range included in the energy data profile.

The transaction generator 240 may generate an energy blockchain transaction based on message data that does not need to be corrected or message data corrected by the message corrector 230 and transmit the generated energy blockchain transaction to a blockchain system. In this case, the transaction generator 240 may perform an optimal rearrangement function to prevent message data having the same key value from being stored in the same block. In addition, the transaction generator 240 may set household identification data as a key value and set a message included in the optimally rearranged message data as a data value to generate an energy blockchain transaction corresponding to a household.

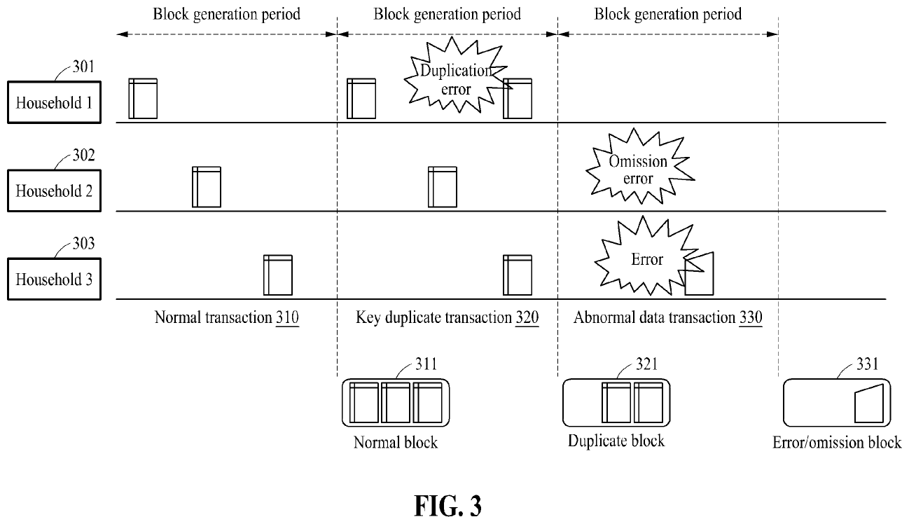

FIG. 3 is a diagram illustrating example problems that may occur in energy blockchain transactions according to an example embodiment.

A transaction that is to be generated in a blockchain system when household #1 301, household #2 302, and household #3 303 each transmits one message to a blockchain system for each block generation period may be a normal transaction 310 including a normal block 311.

However, as shown in FIG. 3, when household #1 301 transmits a plurality of messages for one block generation period, transactions of household #1 301 may be treated as an error in the blockchain system and may not be added to a block. In this case, a transaction generated in the blockchain system may be a key duplicate transaction 320 including a duplicate block 321.

In addition, as shown in FIG. 3, when household #2 302 does not transmit even a single message during a block generation period, omission may occur in the blockchain system. In addition, when a message transmitted from household #3 303 includes an error, an error may occur in the blockchain system. In these cases, a transaction generated in the blockchain system may be an abnormal data transaction 330 including an error/omission block 331.

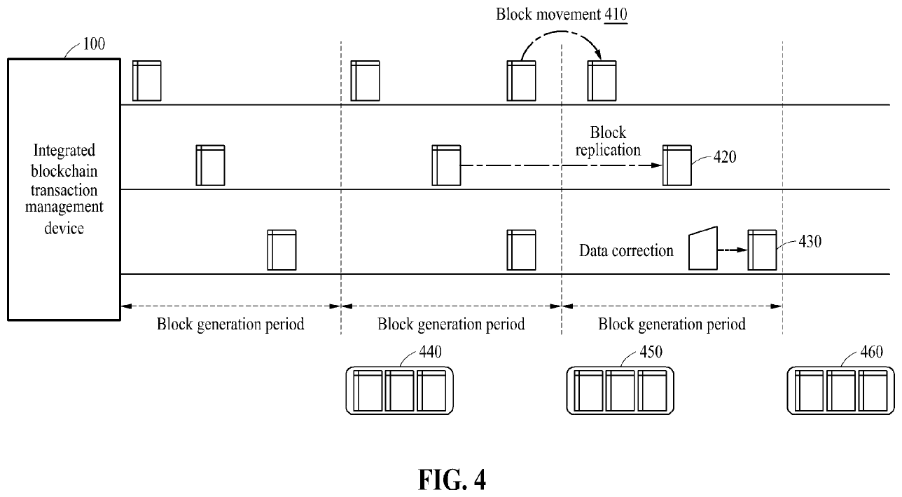

FIG. 4 is a diagram illustrating an example process of energy blockchain transaction management according to an example embodiment.

For example, when a problem shown in FIG. 3 occurs, the energy blockchain transaction management device 100 may process it to prevent an error as shown in FIG. 4.

When household #1 301, household #2 302, and household #3 303 each transmits one message to a blockchain system for each block generation period, the energy blockchain transaction management device 100 may output a transaction including a normal block 440.

When household #1 301 transmits a plurality of messages for one block generation period, the energy blockchain transaction management device 100 may transform a first received message among messages received during the block generation period into a transaction without a change. In addition, the energy blockchain transaction management device 100 may move a subsequently received message 410 to message data of a subsequent block generation period as shown in FIG. 4, thereby outputting a transaction including a normal block 450 even when duplication occurs in the process of transmitting messages from the collectors. In this case, the energy blockchain transaction management device 100 may transform the message 410 into a transaction and output it in the subsequent block generation period.

In addition, when an omission occurs in the blockchain system during a third block generation period, the energy blockchain transaction management device 100 may identify household #2 302 that has not transmitted a message. The energy blockchain transaction management device 100 may extract a message transmitted from household #2 302 during a previous block generation period (or a second block generation period). The energy blockchain transaction management device 100 may then perform data replication for setting the extracted message as a message 420 transmitted from household #2 302 during the third block generation period, thereby outputting a transaction including a normal block 460 even when an omission occurs in the process of transmitting messages from the collectors.

When an error occurs during the third block generation period, the energy blockchain transaction management device 100 may correct a message including error data and transform a corrected message 430 into a transaction, thereby outputting a transaction including the normal block 460 even with the occurrence of the error.

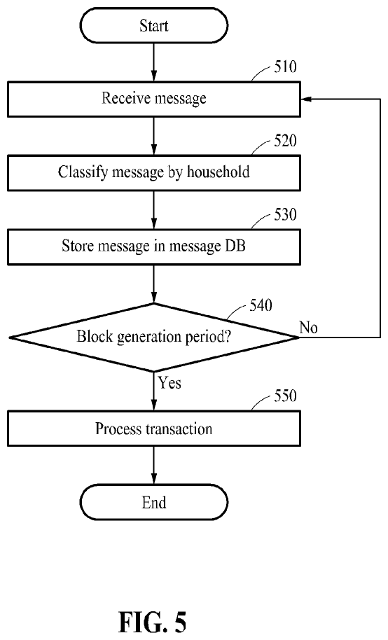

FIG. 5 is a flowchart illustrating an energy blockchain transaction management method according to an example embodiment.

In operation 510, the household-specific message classifier 210 may receive messages including energy-related data of respective households from collectors installed respectively in the households. For example, the message classifier 210 may receive an energy consumption data storing API, an energy production data storing API, and an energy storage data storing API from the energy consumption data collector 110, the power generation and status data collector 120, and the charging/discharging status data collector 130, respectively.

In operation 520, the message classifier 210 may classify the messages received in operation 510 by household based on household identification data. In this case, the message classifier 210 may set the household identification data as a key value of blockchain data, and process a message received from a collector installed in a corresponding household as a data value to generate message data. The message data may include the messages received from the collectors during a block generation period and may be stored in the message DB 220 in a unit of the block generation period.

In operation 530, the message classifier 210 may store the message data generated in operation 520 in the message DB 220.

In operation 540, the message corrector 230 may check whether the block generation period has elapsed. When the block generation period has elapsed, the message corrector 230 may perform operation 550. When the block generation period has not elapsed, the message corrector 230 may be set to a standby state, and the message classifier 210 may perform operations 510 to 530.

In operation 550, the message corrector 230 may perform transaction processing based on the message data stored in the message DB 220 during the block generation period. The transaction generator 240 may generate an energy blockchain transaction based on message data that does not need to be corrected or message data corrected by the message corrector 230 and transmit the generated energy blockchain transaction to the blockchain system. In this case, the transaction generator 240 may perform an optimal rearrangement function to prevent message data with the same key value from being stored in the same block. In addition, the transaction generator 240 may set household identification data as a key value and set a message included in the optimally rearranged message data as a data value to generate an energy blockchain transaction corresponding to a household.

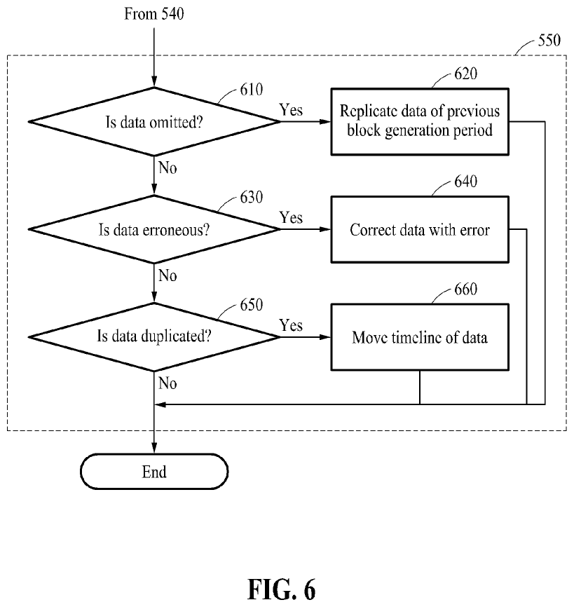

FIG. 6 is a flowchart illustrating a transaction processing process of an energy blockchain transaction management method according to an example embodiment. Operations 610 to 660 described below with reference to FIG. 6 may be included in operation 550 described above with reference to FIG. 5.

In operation 610, the message corrector 230 may check whether a data omission error has occurred. The message corrector 230 may search message data for a household that has not transmitted a message during a block generation period. When the household that has not transmitted a message during the block generation period is retrieved from the message data, the message corrector 230 may determine that a data omission error has occurred and perform operation 620. In addition, when the household that has not transmitted a message during the block generation period is not retrieved from the message data, the message corrector 230 may determine that a data omission error has not occurred and perform operation 630.

In operation 620, the message corrector 230 may identify household identification data of the retrieved household. The message corrector 230 may then extract a message corresponding to the household that has not transmitted a message during the block generation period from message data of a previous block generation period using the identified household identification data. The message corrector 230 may then perform data replication to set the extracted message as a message received from the identified household during the block generation period and add it to the message data.

In operation 630, the message corrector 230 may identify whether error data is included in each of the messages included in the message data. When a message including the error data is identified, the message corrector 230 may perform operation 640. When a message including the error data is not identified, the message corrector 230 may perform operation 650.

In operation 640, the message corrector 230 may correct the message identified in operation 630.

In operation 650, the message corrector 230 may identify, from the message data, a household from which duplicate messages have been received. When the household from which the duplicate messages have been received is identified, the message corrector 230 may perform operation 660. When the household from which the duplicate messages have been received is not identified, the message corrector 230 may end the operations.

In operation 660, the message corrector 230 may identify a first received message among messages corresponding to the identified household. The message corrector 230 may then move at least one remaining message, excluding the identified message, among the messages corresponding to the identified household, to message data of a subsequent block generation period.

Various example embodiments of the present disclosure described herein provide a method and system for collecting, in an integrated manner, energy data such as energy production, consumption, and storage data at the community level, and classifying the collected energy data by individual households and processing it in a form optimized for blockchain registration. The example embodiments of the present disclosure may also employ a technology for correcting errors and omissions in the energy data.

In addition, the example embodiments of the present disclosure provide a method and system for rearranging transactions based on a blockchain generation period to prevent blockchain errors that may occur when duplicate transactions are added to the same block, thereby enabling a stable operation of a blockchain system.

In addition, the example embodiments of the present disclosure provide a method and system for efficiently managing energy data generated in various environments, generating a blockchain transaction that supports data reliability and accuracy, and preventing an error that may occur due to duplicate transactions in the same block by applying a block generation period, thereby enabling a stable operation of a plus energy blockchain system.

The method according to example embodiments of the present disclosure may be written in a computer-executable program and may be implemented as various recording media such as magnetic storage media, optical reading media, or digital storage media.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by or incorporated in special purpose logic circuitry.

In addition, non-transitory computer-readable media may be any available media that may be accessed by a computer and may include all computer storage media and transmission media.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In a specific case, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

What is claimed is:

1. An energy blockchain transaction management method, comprising:
obtaining message data generated by collecting messages comprising energy-related data of respective households from collectors installed respectively in the households;
analyzing the message data and correcting the message data based on an analysis result obtained by the analyzing; and
generating an energy blockchain transaction based on the corrected message data and transmitting the generated energy blockchain transaction to a blockchain system.

2. The energy blockchain transaction management method of claim 1, wherein the message data comprises messages received from the collectors during a block generation period and is stored in a unit of the block generation period.

3. The energy blockchain transaction management method of claim 1, wherein the correcting comprises:
identifying, from the message data, a household that has not transmitted a message during a block generation period;
extracting a message corresponding to the identified household from message data of a previous block generation period; and
setting the extracted message as a message received from the identified household during the block generation period and adding the set message to the message data.

4. The energy blockchain transaction management method of claim 1, wherein the correcting comprises:
identifying, from the message data, a household from which duplicate messages have been received;
identifying a first received message among the messages corresponding to the identified household; and
moving at least one remaining message, excluding the identified message, among the messages corresponding to the identified household, to message data of a subsequent block generation period.

5. The energy blockchain transaction management method of claim 1, wherein the correcting comprises:
identifying whether each of the messages comprised in the message data comprises error data; and
when a message comprising the error data is identified, correcting the identified message.

6. The energy blockchain transaction management method of claim 1, wherein each of the messages comprises at least one of:
an energy consumption data storing application programming interface (API) that is generated by collecting energy consumption data from each of the households by an energy consumption data collector in each of the collectors;
an energy production data storing API that is generated by collecting operational status data of solar power or fuel cell power generation equipment installed in each of the households by a power generation and status data collector in each of the collectors; or
an energy storage data storing API that is generated by collecting charging and discharging status data of an energy storage device installed in each of the households by a charging and discharging status data collector in each of the collectors.

7. The energy blockchain transaction management method of claim 1, further comprising:
classifying the messages by household based on household identification data,
wherein the transmitting to the blockchain system comprises:
setting the household identification data as a key value and setting each of the messages as a data value, and generating an energy blockchain transaction corresponding to a household.

8. An energy blockchain transaction management system, comprising:
collectors installed in respective households and configured to collect energy-related data of the respective households and transmit messages data comprising the collected data; and
an integrated blockchain transaction management device configured to analyze message data, correct the message data based on an analysis result obtained by the analyzing, generate an energy blockchain transaction based on the corrected message data, and transmit the generated energy blockchain transaction to a blockchain system.

9. The energy blockchain transaction management system of claim 8, wherein the message data comprises messages received during a block generation period from the collectors and is stored in a unit of the block generation period.

10. The energy blockchain transaction management system of claim 8, wherein each of the collectors comprises at least one of:
an energy consumption data collector configured to collect energy consumption data about energy consumed by each of the households;
a power generation and status data collector configured to collect operational status data of solar power or fuel cell power generation equipment installed in each of the households; or
a charging and discharging status data collector configured to collect charging and discharging status data of an energy storage device installed in each of the households.

11. An integrated blockchain transaction management device, comprising:
a household-specific message classifier configured to obtain message data generated by collecting messages comprising energy-related data of respective households from collectors installed respectively in the households;
a message corrector configured to analyze the message data and correct the message data based on an analysis result obtained by the analyzing; and
a transaction generator configured to generate an energy blockchain transaction based on the corrected message data and transmit the generated energy blockchain transaction to a blockchain system.

12. The integrated blockchain transaction management device of claim 11, wherein the message corrector is configured to:
identify, from the message data, a household that has not transmitted a message during a block generation period, extract a message corresponding to the identified household from message data of a previous block generation period, and set the extracted message as a message received from the identified household during the block generation period and add the set message to the message data.

13. The integrated blockchain transaction management device of claim 11, wherein the message corrector is configured to:
identify, from the message data, a household from which duplicate messages have been received, identify a first received message among the messages corresponding to the identified household, and move at least one message, excluding the identified message, among the messages corresponding to the identified household to message data of a subsequent block generation period.

14. The integrated blockchain transaction management device of claim 11, wherein the message corrector is configured to:
identify whether each of the messages comprised in the message data comprises error data and, when a message comprising the error data is identified, correct the identified message.

15. The integrated blockchain transaction management device of claim 11, wherein each of the messages comprises at least one of:
an energy consumption data storing application programming interface (API) that is generated by collecting energy consumption data from each of the households by an energy consumption data collector in each of the collectors;
an energy production data storing API that is generated by collecting operational status data of solar power or fuel cell power generation equipment installed in each of the households by a power generation and status data collector in each of the collectors; or
an energy storage data storing API that is generated by collecting charging and discharging status data of an energy storage device installed in each of the households by a charging and discharging status data collector in each of the collectors.

16. The integrated blockchain transaction management device of claim 11, wherein the household-specific message classifier is configured to:
classify the messages by household based on household identification data,
wherein the transaction generator is configured to:
set the household identification data as a key value and set each of the messages as a data value, and generate an energy blockchain transaction corresponding to a household.
